(19) United States
(12) Patent Application Publication
(10) Pub. No.: US 2004/0101264 A1
(43) Pub. Date: May 27, 2004

(54) Programmable integrated-optical device and a method for making and using the same

(76) Inventors: William Ian McAlexander, Redwood City, CA (US); Douglas M. Baney, Los Altos, CA (US); Jeffery Noland Miller, Los Altos Hills, CA (US)

Correspondence Address: AGILENT TECHNOLOGIES, INC., Legal Department DL420, Intellectual Property Administration, P.O. Box 7599, Loveland, CO, 80537-0599, US

(21) Appl. No.: 10/306,139

(22) Filed: Nov. 27, 2002

(51) Int. Cl. G02B 6/10; G02B 6/12

(52) U.S. Cl. 385/132; 385/14; 385/40

(57) ABSTRACT

An integrated-optical device comprising a photorefractive, quadratically electro-optic substrate having at least one optical waveguide channel and at least two electrodes. The photorefractive nature of the substrate and the quadratically electro-optic properties of the substrate enable optical waveguides of variable transmission to be formed in the substrate by applying a differential voltage to the substrate as it is exposed to relatively high intensity light. During operation, when a differential voltage is applied, the refractive index of the exposed regions of the substrate is altered and the exposed regions constitute one or more optical waveguides that are light-guiding with a transmission efficiency based on the magnitude of the voltage differential. By selecting the regions of the substrate that are exposed during the exposure period, and/or the locations on the substrate at which the differential voltage is applied during the exposure period, lightpath circuits having desired configurations can be stored in the substrate in the form of patterns of distributions of space charge. Because the substrate is photorefractive and quadratically electro-optic, these configurations of lightpaths can be erased and new lightpath configurations can be programmed into the substrate.

### TECHNICAL FIELD OF THE INVENTION

The present invention relates to optics, and, more particularly, to a programmable integrated-optical device that comprises at least one optical waveguide formed in a photorefractive, quadratically electro-optic substrate, and electrodes for applying a differential voltage to the substrate to alter the refractive index of the optical waveguide so that it becomes an optical transmission path.

### BACKGROUND OF THE INVENTION

The communications industry utilizes a variety of optical devices in optical networks in which information is communicated in the form of light pulses over optical fibers. Due to the ever-increasing need to improve communications networks, ongoing efforts are being made in the communications industry to design and construct optical devices having improved performance and efficiency and other enhanced optical characteristics.

Optical devices generally fall into one of two categories, namely, macroscopic optical devices and microscopic optical devices. “Free-space optics” is a phrase often used to describe macroscopic optical devices, such as prisms and lenses, which operate on light in a particular manner for a particular purpose. Due to the 3-D nature of these optical components, light propagates through them over distances of millimeters or centimeters, and thus they are referred to as operating on light on a “macroscopic” scale. These types of optical components are also commonly referred to as “bulk” components.

Due to the need to provide optical devices that perform these types of operations on a “microscopic” scale (i.e., on the order of micrometers), optical integrated circuits (OICs) have been developed that have optical elements that are integrated together in a substrate material. These devices are typically thought of as not being 3-D in nature due to the minuteness of the elements within them that operate on light. An example of an OIC that is designed to operate on light on a microscopic scale is disclosed in U.S. Pat. No. 6,052,497. This patent discloses an integrated add/drop filter having a piezoelectric substrate such as lithium niobate, a waveguide formed by interdiffusion of a narrow strip of material such as zinc into the substrate and an interdigital transducer (IDT) formed in the substrate. Other devices and techniques that also rely on the generation of acoustic waves in a substrate to create Bragg reflection of light of a particular wavelength are disclosed in U.S. Pat. Nos. 5,652,809 and 5,611,004. One of the disadvantages of such devices is that the waveguides are formed by diffusion of a material having a refractive index that is different from the refractive index of the substrate. Because the waveguides are fixed in the substrate, they cannot be removed and formed in different locations on the substrate. Thus, the lightpaths formed in the substrate are fixed and cannot be altered without destroying the device.

A need exists for a fully-integrated optical device that is capable of operating on light on a microscopic scale and that can be programmed and reprogrammed to enable the optical waveguides formed in the device to be altered so that the device can be configured and reconfigured.

### SUMMARY OF THE INVENTION

In accordance with the invention, an integrated-optical device comprising a photorefractive, quadratically electro-optic substrate comprising at least one optical waveguide channel and at least two electrodes is provided. To create the device, an electric field is applied to the substrate as it is exposed to relatively high intensity light. This causes the substrate to store a space charge that correlates to a refractive index pattern. Application of an electric field during operation allows the space charge pattern to appropriately alter the refractive index of the substrate in such a manner that the optical waveguide channel becomes an optical transmission lightpath. The pattern of one or more lightpaths corresponds to the exposed regions of the substrate. The lightpath pattern stored in the photorefractive substrate can be erased and a new pattern can be written into the substrate following the exposure procedure. Thus, the substrate is rewritable, which enables the lightpath patterns to be altered by erasing a current lightpath pattern formed in the substrate and writing a new lightpath pattern into the substrate.

Because the photorefractive substrate is also quadratically electro-optic, then the presence, absence or variation of a bias voltage during operation causes the refractive indices of the WGs to change such that they become light-guiding with a transmission efficiency that is based on the magnitude of the bias voltage. When the bias voltage is not applied, the WGs are not optically transmitting lightpaths. This feature of the present invention enables the lightpath circuit formed in the substrate to be selectively controlled because the WGs forming the lightpath circuit can be selectively turned off and on during operation. Furthermore, by applying a bias voltage of various levels (i.e., either a static level or a dynamically varying level), the WG will act as a variable transmission device providing for controllable attenuation functions. The WG has light-guiding transmission efficiency that is based on the magnitude of the voltage differential. The differential voltage does have not be static, but can be dynamically varied to enable modulation of the light being guided along the lightpath. Dynamically varying the attenuation allows for amplitude modulation, whereas dynamically varying the refractive index allows for phase modulation.

These and other features and advantages of the present invention will become apparent from the following description, drawings and claims.

### BRIEF DESCRIPTION OF THE DRAWINGS

FIG. 1 is a perspective view of the integrated-optic device of the present invention in accordance with an example embodiment in which a single optical waveguide has been written into the substrate material.

FIG. 2 is a perspective view of the integrated-optical device of the present invention in accordance with an example embodiment in which multiple optical waveguides have been written into the substrate material.

FIG. 3 is a perspective view of the integrated-optical device of the present invention shown in accordance with an example embodiment comprising an array of addressable electrodes.

### DETAILED DESCRIPTION OF THE INVENTION

In accordance with the present invention, one or more optical waveguide (WG) channels are formed in a substrate that comprises a photorefractive material that is also quadratically electro-optic. The substrate material of the present invention can be any material that satisfies the criterion of being photorefractive and quadratically electro-optic. The meaning of the term photorefractive generally refers to the ability of a material to locally change its refractive index in response to exposure to light. If a material is characterized by non-zero electro-optical coefficients, it possesses electro-optical properties. The term quadratically electro-optic will be used herein to denote a material having an induced birefringence that is proportional to the square of an applied electric field. This property allows the refractive index of the material to change as a result of the application of a voltage or low-frequency electric field.

Because the substrate is photorefractive and quadratically electro-optic, WGs can be written into the substrate by exposing regions of the substrate to relatively high intensity light. When an electric field is applied to the substrate or a portion thereof during exposure, the substrate will store a space charge that correlates to a refractive index pattern. Application of an electric field during operation causes the space charge pattern to appropriately alter the refractive index of the substrate, thereby causing the WGs to become optical transmitting lightpaths. This allows light to be transmitted through the substrate along the lightpaths, which correspond to the exposed regions. At some later time, if desired, the space charge stored in the substrate can be erased and a new pattern of WGs can be written into the substrate. Thus, the substrate is rewritable, which enables the patterns of WGs, i.e., the lightpath circuit comprising the WGs, to be altered by erasing a current pattern of WGs formed in the substrate and writing a new pattern of WGs into the substrate.

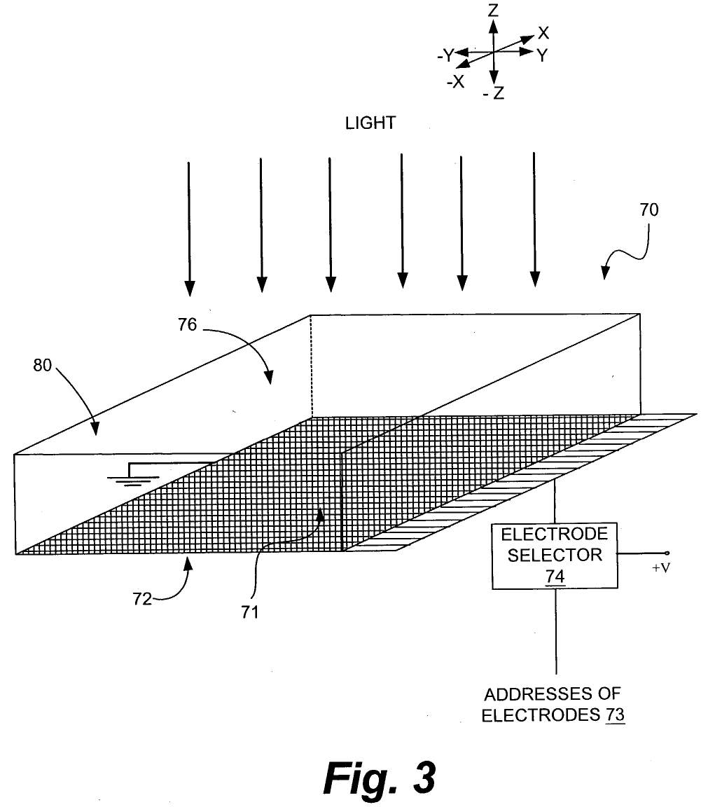

Because the substrate is quadratically electro-optic, during operation, application of a voltage differential across the substrate causes the refractive indices of the stored WGs to change such that they become light-guiding with a transmission efficiency that is based on the magnitude of the voltage differential. This feature of the present invention enables the lightpath circuit formed in the substrate to be selectively controlled because the WGs forming the lightpath circuit can be selectively turned off and on during operation. The selective controllability of a lightpath circuit formed in the substrate will be described below with reference to FIG. 3.

In accordance with one embodiment of the present invention, a mask is used during exposure to create a pre-selected pattern of exposed regions in the substrate. As stated above, during exposure, a voltage differential is applied over either the entire substrate or one or more regions of the substrate. During operation, when the differential voltage is applied, the space charge stored in the substrate causes the refractive index of the exposed regions (i.e., the waveguide channels) of the substrate to become optically transmitting lightpaths. Thus, by selectively exposing certain regions of the substrate through a mask as the differential voltage is applied to the substrate, a predetermined pattern of lightpaths are formed in the substrate.

In accordance with another embodiment of the present invention, the substrate is not masked during exposure, but an array of electrodes, or a subset thereof, are activated to form a pattern of regions of the substrate to which the differential voltage was applied during the exposure period. During operation, one or more pairs of the electrodes of the array are selectively addressed and only the regions of the substrate associated with the addressed pairs of electrodes become optically transmissive waveguides, or lightpaths. Thus, by selectively applying the differential voltage to regions of the substrate during exposure and/or during operation, a predetermined pattern of lightpaths are formed in the substrate. As stated above, because the substrate is photorefractive and quadratically electro-optic, the device can be programmed to have a particular lightpath circuit, and subsequently reprogrammed by erasing the current lightpath circuit from the substrate and writing a new lightpath circuit to the substrate. Also, for any given lightpath circuit programmed into the substrate, the paths taken by the light through the circuit can be selectively altered by changing the pairs of electrodes of the array that are addressed during operation (i.e., by altering which pairs of electrodes are activated at a given time).

Materials are known that are both photorefractive and quadratically electro-optic and therefore are suitable for use as the substrate of the integrated-optical device of the present invention. For example, one material that is suitable for use as the substrate of the integrated-optic device of the present invention is K₁₋ₓLiₓTa_{1-y}Nb_{y} O₃:Cu, V, which is otherwise referred to in the art as “KLTN”. With this and similar types of materials, optimal performance will occur when they are held at a temperature slightly above the ferroelectric phase transition temperature. This is due to the fact that at this slightly higher temperature, the material has a larger dielectric constant that enables greater refractive index changes to occur in the material. However, as will be understood by those skilled in the art, in view of the description provided herein, other materials that meet these requirements are also suitable for use as the substrate. The substrate is not limited to any material, as long as the material is photorefractive. Substrate materials may also be doped with various ions so as to allow for additional characteristics of the integrated optic device. For example, materials doped with rare-earth ions (such as Er³⁺, Yb³⁺) may be used for forming integrated-optics that possess amplifying characteristics.

In accordance with the present invention, it has been determined that the known process of creating volume holograms in bulk photorefractive materials can be modified and used to form one or more optical WGs in the substrate material to produce an integrated-optical device comprising one or more programmable lightpath circuits. Bulk, or volume, holograms have been used on macroscopic scales for various purposes, including, for example, electric-field multiplexing, as described in a publication entitled “Electric-Field Multiplexing Of Volume Holograms In Paraelectric Crystals”, by Balberg et al., Applied Optics, Vol. 37, No. 5, Feb. 10, 1998, which is incorporated herein by reference in its entirety. Other publications that discuss various aspects of volume holograms, such as their use in optical switching and storage efficiency, include, respectively, “Free-Space Optical Cross-Connect Switch By Use Of Electroholography”, Applied Optics, Vol. 39, No. 5, Feb. 10, 2000, by Pesach et al., and “Investigation of the Holographic Storage Capacity Of Paraelectric K₁₋ₓLiₓTa_{1-y}Nb_{y} O₃:Cu, V”, Optics Letters, Vol. 23, No. 8, Apr. 15, 1998, by Pesach et al., which are also incorporated herein by reference in their entireties. These holograms are comprised of what are commonly referred to as diffractive Bragg gratings (DBGs).

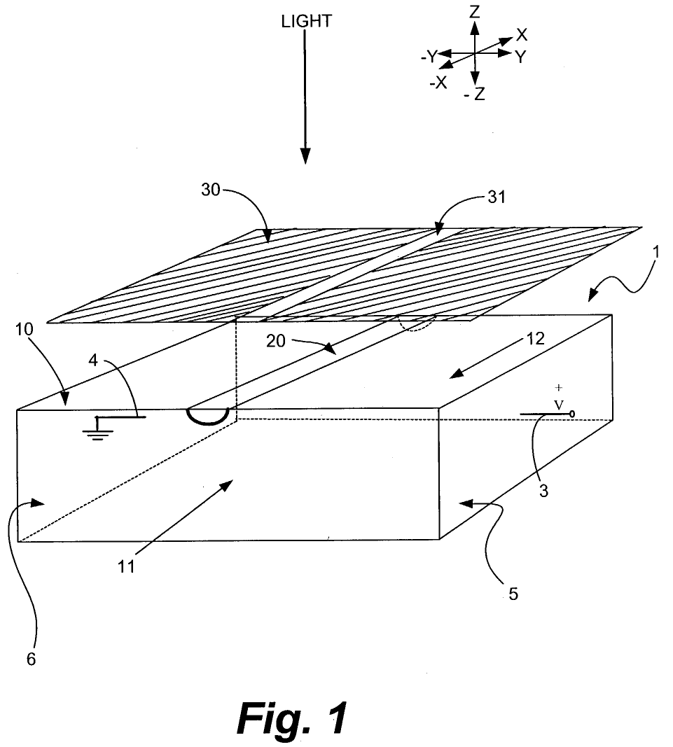

FIG. 1 is a perspective view of an example embodiment of the integrated-optical device 1 of the present invention. The integrated-optical device 1 comprises a substrate 10 that is photorefractive and quadratically electro-optic. The substrate 10 has electrodes 3 and 4 formed on opposite sides 5 and 6, respectively, of the substrate 10 to enable a voltage differential to be applied across the substrate 10. The locations of the electrodes 3 and 4 are not limited to any particular locations. The electrodes could instead be located on sides 11 and 12, for example.

To create the lightpath circuit, one or more regions of the photorefractive substrate 10 of the device 1 of the present invention are exposed to light of relatively high intensity through a mask 30 having one or more openings 31 formed therein that allow the light to pass through the mask 30 and into the substrate 10. During the exposure period, a voltage differential is applied across the substrate via electrodes 3 and 4. The result is that the exposed regions of the substrate 10 will have a different refractive index than the unexposed regions of the substrate 10 and the space charge is encoded in the substrate during exposure. During operation, the index of refraction of the exposed regions will be alterable by applying a voltage to electrodes 3 and 4 that couples with the space charge. Because the electrode 4 is tied to ground, only the bias voltage applied to electrode 3 needs to be changed in order to alter the voltage differential across the substrate 10. Of course, it is not necessary that one of the electrodes be tied to ground, but only that the voltage applied to the electrodes 3 and 4 be different so that a voltage differential is applied across the substrate 10 during exposure and operation.

The term “lightpath”, as that term is used herein, is intended to denote either a single WG channel or a combination of various portions of different WG channels. For example, light input to one particular WG channel may be guided along that particular WG channel through a portion of the device, and then switched onto one or more other WG channels that guide the light to an output of a WG channel of the device. Thus, a lightpath may comprise portions of multiple WG channels or may comprise a single WG channel.

In FIG. 1, the mask 30 is depicted as having a single opening 31 in it to cause a single WG 20 to be formed in the substrate 10. Although a single WG 20 is shown in FIG. 1, the present invention is not limited with respect to the number of WGs that may be formed in the integrated-optical device. As discussed below in detail, preferably multiple WGs are formed in the substrate to create a lightpath circuit, with each lightpath corresponding to a WG formed in the substrate or a combination of portions of multiple WGs formed in the substrate. During operation, when light is coupled into the WG 20 and a bias voltage is applied across the substrate 10, the light will propagate through the WG 20. The light coupled into the WG 20 will remain in the WG as it propagates through the substrate 10 due to the refractive index difference of the WG 20 in comparison to the unexposed remainder of the substrate 10.

In essence, the application of the bias voltage to electrode 3 causes refractive indices of the exposed and unexposed regions of the substrate 10 to change such that the index of refraction of the WG 20 is different from the refractive index of the portions of the substrate 10 that are outside of the WG 20 (i.e., the unexposed regions of the substrate 10). Therefore, the light coupled into the WG 20 will propagate through the WG 20 and remain in the WG 20 due to internal reflection caused by the refractive index difference. When the bias voltage is not applied, the WG 20 will be non-transmissive to light of the wavelength that is being used to communicate information through the WGs. Furthermore, by applying a bias voltage of various levels (i.e., either different static levels or dynamically varying levels), the WG 20 will act as a variable transmission device providing for controllable attenuation functions. The WG 20 has light-guiding transmission efficiency that is based on the magnitude of the voltage differential. The differential voltage does have not be static, but can be dynamically varied to enable modulation of the light being guided along the lightpath. Dynamically varying the attenuation allows for amplitude modulation, whereas dynamically varying the refractive index allows for phase modulation.

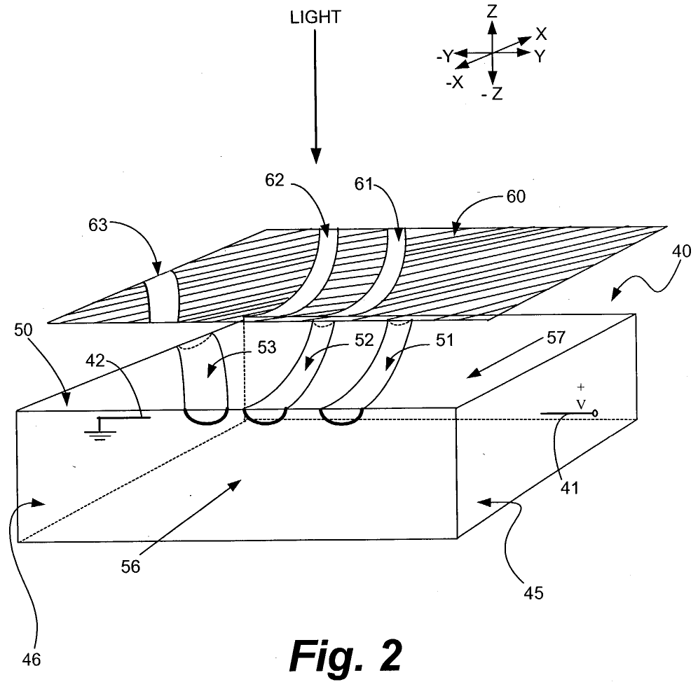

FIG. 1 is a simple example of the integrated-optical device of the present invention that is presented herein to provide a simplified explanation of the present invention. In accordance with the preferred embodiment of the present invention, the photorefractive substrate 10 has multiple WGs formed therein. FIG. 2 is an example embodiment of the integrated-optical device 40 of the present invention having multiple WGs 51, 52 and 53 formed in the substrate 50. The WGs 51, 52 and 53 correspond to the regions of the substrate 50 that are exposed to light through openings 61, 62 and 63, respectively, in the mask 60. When a differential voltage is applied across the substrate 50 by application of a bias voltage to electrodes 41 and 42 formed in sides 45 and 46, respectively, of the substrate 50, light coupled into any one or all of the WGs 51, 52 and/or 53 will propagate through the WGs 51, 52 and/or 53. When the bias voltage is not applied, light will not be guided by the WGs 51, 52 and 53 (i.e., they will not be optical transmitting lightpaths). For example purposes, it will be assumed that the inputs to WGs 51, 52 and 53 are in side 56, that the outputs of WGs 51 and 52 are in side 57, and that the output of WG 53 is in side 46, as shown. The inputs and outputs of WGs 51, 52 and 53 may be secured to optical fibers (not shown) to enable light propagating along the optical fibers to be selectively passed through or blocked by the integrated-optical device 40, depending on whether the bias voltage is applied across the substrate 50.

In the example embodiments of FIGS. 1 and 2, a differential voltage is applied across the entire substrates during the exposure period and only certain portions of the substrates are exposed through openings formed in masks. During operation, the voltage is applied across the entire substrates in order to turn on the WGs (i.e., to cause the WGs to be transmissive). FIG. 3 is a perspective view of another example embodiment of the integrated-optical device 70 of the present invention. In contrast to the embodiments shown in FIGS. 1 and 2, the entire substrate 80 is exposed during the exposure period, rather than using a mask to prevent certain regions from being exposed. However, an array of electrodes 71 is formed on the surface 72 of the substrate 80. During the exposure period, addresses of electrodes 73 are provided to an electrode selector 74, which may be, for example, a multiplexer. In accordance with the electrode addresses received by the electrode selector 74, a differential voltage is applied locally to individual regions of the substrate 80. This creates a pattern within the substrate 80 of regions that have altered refractive indices. The array of electrodes 71 could, alternatively, be formed on surface 76 of the substrate 80. Of course, a mask could be used during exposure even in cases where the substrate has an array of electrodes formed thereon such as the array of electrodes 71.

During operation, a bias voltage can be applied to different electrodes within the array of electrodes 71 to selectively configure WGs in the substrate 80. In other words, the device 70 can be programmed by selectively addressing electrodes of the electrode array 71 via electrode selector 74. Thus, a lightpath circuit in the device 70 can be can configured and reconfigured by selecting the electrodes to which the bias voltage will be applied. For example, the addresses 73 provided to the electrode selector 74 can be generated by a program being executed by some type of processor (not shown) that reconfigures the lightpath in accordance with data received by the processor.

Formation of the electrodes shown in FIGS. 1, 2 and 3 can be accomplished by a variety of techniques. These techniques may range from various metal deposition techniques such as, for example, e-beam evaporation (for electrodes positioned on surfaces of the substrate 10), to a combination of those techniques with known etching techniques such as, for example, an ion-beam milling or reactive-ion etching (when electrodes are to be formed in the trenches within the body of the substrate) technique.

The WGs, or lightpaths, formed in the substrate will be preserved for at least some period of time. The WGs can be erased by, for example, uniformly exposing the substrate to light at a particular wavelength (e.g., ultraviolet light) and/or by subjecting the substrate to elevated temperatures. Also, multiple instances of the integrated-optical device can be cascaded to produce a cascaded integrated-optical device. This would allow greater programmability because any device could be programmed and reprogrammed without affecting the other devices. It should also be noted that the device of the present invention is fully compatible with batch, or large scale, IC fabrication technologies. Those skilled in the art will understand how the device of the present invention can be mass produced using large scale IC fabrication techniques (VLSI) from the discussion of the device provided herein in view of the level of skill in the art of IC fabrication.

The present invention has been described with reference to certain example embodiments. However, the present invention is not limited to the embodiments described above, as will be understood by those skilled in the art from the discussion provided herein. The manner in which the integrated-optical device of the present invention functions depends on a large number of parameters, including the material used as the substrate, the wavelength of light upon which the device operates, the refractive indices involved, etc. Those skilled in the art will understand the manner in which these and other parameters can be selected to create a lightpath circuit having a desired performance. Those skilled in the art will also understand that many modifications can be made to the example embodiments described herein and that all such modifications are within the scope of the present invention.

What is claimed is:

1. An integrated-optical device comprising a lightpath circuit, the integrated-optical device comprising:
a photorefractive, quadratically electro-optic substrate;
at least one optical waveguide channel integrated with the substrate, said at least one optical waveguide channel having an input and an output;
at least first and second electrodes, such that when a voltage differential is applied between the electrodes, a voltage differential is applied across said at least one optical waveguide channel, thereby causing said at least one optical waveguide channel to become light-guiding with a transmission efficiency based on a magnitude of the voltage differential.

2. The integrated-optical device of claim 1, wherein the magnitude of the voltage differential applied across said at least one optical waveguide channel is dynamically varied to modulate the light-guiding transmission efficiency of said at least one optical waveguide channel.

3. The integrated-optical device of claim 1, wherein application of the voltage differential across said at least one optical waveguide channel is dynamically varied to modulate a refractive index of said at least one optical waveguide channel.

4. The integrated-optical device of claim 1, such that when the differential voltage is applied between the electrodes, a refractive index of said at least one optical waveguide channel becomes different from a refractive index of portions of the substrate surrounding said at least one optical waveguide channel, thereby causing light propagating along said at least one optical waveguide channel to remain in said at least one optical waveguide channel as a result of internal reflection of the light within the waveguide channel due to the differences between the refractive indices of said at least one optical waveguide channel and the portions of the substrate surrounding said at least one optical waveguide channel.

5. The integrated-optical device of claim 1, wherein the substrate comprises a compound K₁₋ₓLiₓTa_{1-y}Nb_{y} O₃:Cu, V (KLTN).

6. The integrated-optical device of claim 1, wherein multiple optical waveguide channels are integrated with the substrate, and wherein each optical waveguide channel becomes light-guiding when a voltage differential is applied between the electrodes.

7. The integrated-optical device of claim 6, wherein said multiple optical waveguide channels and said substrate are integrally formed in the integrated-optical device and are of the same material, and wherein said multiple optical waveguide channels have a refractive index that is different from a refractive index of portions of the substrate outside of said multiple optical waveguide channels.

8. The integrated-optical device of claim 6, wherein said multiple optical waveguide channels constitute a lightpath circuit, and wherein a surface of the substrate has an array of electrodes thereon, the array comprising multiple pairs of electrodes, each pair of electrodes being arranged to apply a differential voltage across a respective area of the substrate, and wherein when the differential voltage is applied by a particular pair of electrodes to a respective area of the substrate, an index of refraction of the respective area associated with the particular pair of electrodes is altered to cause the respective area associated with the particular pair of electrodes to be light-guiding with a transmission efficiency based on the magnitude of the voltage differential.

9. The integrated-optical device of claim 8, wherein the electrode pairs are individually addressable such that any pair of electrodes can be turned on by addressing the pair of electrodes to cause a differential voltage to be applied across the area of the substrate associated with the addressed pair of electrodes such that when the addressed pair turns on, the refractive index of the area of the substrate associated with the addressed pair is altered.

10. The integrated-optical device of claim 9, wherein multiple pairs of electrodes are addressed at the same time, thereby causing differential voltages to be applied across multiple respective regions of the substrate, and wherein said multiple respective regions of the substrate constitute a plurality of lightpaths that are light-guiding, the lightpaths forming a lightpath circuit that is programmed into the integrated-optical device.

11. The integrated-optical device of claim 10, wherein the addresses can be changed to cause different pairs of electrodes to be addressed, thereby altering the lightpaths and reprogramming the lightpath circuit.

12. A method for propagating light through a lightpath circuit formed in an integrated-optical device, the lightpath circuit being comprising one or more optical waveguide channels formed in a photorefractive, quadratically electro-optic substrate of the integrated-optical device, the substrate having two or more electrodes thereon, the method comprising:
providing the integrated-optical device having the lightpath circuit formed therein; and
creating a voltage differential between at least two of said electrodes to create a voltage differential across a region of the substrate that includes at least a portion of one of said optical waveguide channels, the voltage differential created across a region altering the refractive index of that region, the region having the altered refractive index being light-guiding with a transmission efficiency based on the magnitude of the voltage differential.

13. The method of claim 12, wherein the substrate comprises a compound K₁₋ₓLiₓTa_{1-y}Nb_{y} O₃:Cu, V (KLTN).

14. The method of claim 12, wherein the substrate of the integrated-optical device has multiple optical waveguide channels formed therein, and wherein each optical waveguide channel becomes optically transmissive when a differential voltage is created between two of the electrodes, the two electrodes being located at different locations on the substrate such that the creation of the differential voltage between the two electrodes results in a differential voltage being applied across each of the optical waveguide channels.

15. The method of claim 12, wherein the substrate of the integrated-optical device has multiple optical waveguide channels formed therein, and wherein said multiple optical waveguide channels and said substrate are integrally formed in the integrated-optical device and are of the same material, and wherein said multiple optical s waveguide channels have a refractive index that is different from a refractive index of portions of the substrate outside of said multiple optical waveguide channels.

16. The method of claim 15, wherein a surface of the substrate has an array of electrodes thereon, the array comprising multiple pairs of electrodes, each pair of electrodes being arranged to apply a differential voltage across a respective area of the substrate, and wherein the step of creating a voltage differential between at least two of said electrodes includes the step of creating a differential voltage between at least two of said pairs of electrodes to cause the index of refraction of the areas of the substrate associated with the two pairs of electrodes to be altered, the areas of the substrate having the altered index of refraction being optically transmissive.

17. The method of claim 16, wherein the electrode pairs are individually addressable such that any pair of electrodes can be turned on by addressing the pair of electrodes to cause a differential voltage to be applied across the area of the substrate associated with the addressed pair of electrodes, and wherein when the addressed pair turns on, the refractive index of the area of the substrate associated with the addressed pair is altered.

18. The method of claim 17, wherein the step of creating a differential voltage between at least two of said pairs of electrodes includes the step of addressing multiple pairs of electrodes at the same time to cause differential voltages to be applied across the regions of the substrate associated with the addressed pairs of electrodes, and wherein regions of the substrate associated with the addressed pairs of electrodes constitute a plurality of light-guiding paths, the lightpaths forming a lightpath circuit that is programmed into the integrated-optical device.

19. The method of claim 18, wherein the addresses are selectable and can be changed to cause different pairs of electrodes to be addressed, thereby altering the optically transmissive lightpaths and reprogramming the lightpath circuit.

20. A method of creating an integrated-optical waveguide device having a programmable lightpath circuit formed therein, the integrated-optical device comprising a photorefractive, quadratically electro-optic substrate, the substrate having two or more electrodes thereon for allowing a voltage differential to be applied to the substrate via said two or more electrodes, the method comprising:
forming one or more optical waveguide channels in the substrate by exposing a portion of the substrate to relatively high intensity light through a mask while a voltage differential is applied across at least a portion of the substrate, the exposed portion of the substrate corresponding to said one or more optical waveguide channels.

21. A method of creating an integrated-optical waveguide device having a programmable lightpath circuit formed therein, the integrated-optical device comprising a photorefractive, quadratically electro-optic substrate, the substrate having an array of electrodes thereon for allowing a voltage differential to be applied to different regions of the substrate, the method comprising:
selectively addressing one or more pairs of said array of electrodes, wherein addressing any given pair of the electrodes causes a voltage differential to be applied across a region of the substrate associated with the addressed pair of electrodes; and
exposing at least a portion of the substrate to relatively high intensity light while said one or more pairs of electrodes are being selectively addressed, and wherein any region of the substrate to which the differential voltage is applied and that is exposed becomes a light-guiding path with a transmission efficiency based on the magnitude of the voltage differential.

22. The method of claim 21, wherein during the step of exposing the substrate, a mask is used to control which areas of the substrate are exposed.
